(19) United States
(12) Patent Application Publication
(10) Pub. No.: US 2008/0001919 A1
(43) Pub. Date: Jan. 3, 2008

(54) User Interface Device

(75) Inventor: Antonio Pascucci, Seefeld (DE)

Correspondence Address: HISCOCK & BARCLAY, LLP, 2000 HSBC PLAZA, 100 Chestnut Street, ROCHESTER, NY, 14604-2404, US

(73) Assignee: 3D CONNEXION GMBH

(21) Appl. No.: 10/593,525

(22) PCT Filed: Mar. 16, 2005
(86) PCT No.: PCT/EP05/02806

§ 371 Date: Aug. 10, 2007

(30) Foreign Application Priority Data
Mar. 17, 2004 (EP) 04006382.8

(51) Int. Cl. G06F 3/033; H01H 25/06

(52) U.S. Cl. 345/163

(57) ABSTRACT

The present invention provides a device (100) for manual input of control signals in a computer-related environment, the device comprising: a base (10) for supporting the device on a surface; a first input member (20) mounted on the base (10) for rotary movement about an axis (21) extending generally upwardly from the base (10), the first input member (20) having an axial extent (22) from an end region (23) proximal the base (10) to an end region (23) distal from the base and enclosing a central space (26) within which a sensor arrangement (50) is housed for detecting and interpreting rotary movement of the first input member (20) relative to the base, the first input member (20) having an opening at each of its proximal and distal end regions (23, 24); and a pair of second input members (31, 32) provided at or adjacent said distal end region (24) of the first input member (20), each of said second input members (31, 32) comprising a switch or relay adapted to be actuated by application of finger pressure. Rotary movement of the first input member (20) and/or actuation of the second input members (31, 32) is adapted to generate a corresponding control signal within the computer environment.

### FIELD OF THE INVENTION

The present invention relates to a user interface device for a computing or computer-related environment. More particularly, the invention relates to a device with which a user may manually input control signals in a computing or a computer-related environment.

The present invention has particular application as a hand-operated device which serves as a control signal input interface for a user in the manipulation and processing of digital information, such as digital images, and it will be convenient to describe the invention in this exemplary context. It will be appreciated, however, that the invention is not limited to this application, but may for example also find application in the control of a wide range of robotic and automated machinery.

### BACKGROUND OF THE INVENTION

A broad and ever increasing range of hand-operated devices for user input of control signals in computing or digital applications are currently available in the market-place. The more well-known of these devices include the conventional mouse in its various forms, the joystick and the trackball.

A relatively recent development of the Applicant, described in US patent publication no. 2003/0103217, relates to a sensor arrangement for the detection of relative movements or the relative position of two objects, and to the incorporation of such a sensor arrangement in a user interface device for inputting control signals in a computing environment.

Naturally, the desire and efforts to optimise ergonomics and the ease of handling and operation of such user interface devices are on-going, particularly in relation to a range of specific computer-related applications.

The present invention represents a continuation of that optimisation process, with the control of CAD and image processing software applications in mind. In particular, the present invention is based on the object of creating an improved user interface device from the point of view of functionality and ergonomics, most preferably suited to CAD/CAM and image processing applications.

European patent publication no. 1 152 324 very briefly refers to an icon interface device in the form of a jog-dial for a personal computer. International patent publication no. WO-01/65329 describes a joystick-type computer interface device, in which a sensor mechanism for detecting rotational movement in three degrees of freedom is incorporated in the base.

U.S. Pat. No. 6,225,980 and international patent publication no. WO-03/046822 describe input devices for computer controlled functions, comprising rotary dials having rotary position sensors incorporated in the base under the rim of the dial. This positioning of the sensors makes the sensor arrangement vulnerable to knocks and shocks, and does not maximise available space. Furthermore, these devices do not provide for an optimised ergonomic configuration.

### SUMMARY OF THE INVENTION

Broadly, the present invention provides a user interface device for manual input of control signals in a computer-related environment, the device comprising a base for supporting the device on a surface; a first input member mounted on the base for rotary movement about an axis extending generally upwardly from the base, the first input member having an axial extent from an end region proximal the base to an end region distal from the base and enclosing a central space within which a sensor arrangement is housed for detecting and interpreting rotary movement of the first input member relative to the base, the first input member having an opening at each of its proximal and distal end regions; and at least two second input members provided at or adjacent said distal end region of the first input member, each of said second input members comprising a switch or relay adapted to be actuated by application of finger pressure; wherein rotary movement of the first input member and/or actuation of the second input members is adapted to generate a corresponding control signal within the computer environment and wherein the two second input members are mounted such that rotary movement of the first input member relative to the base does not influence or alter the position of the second input members.

The first input member therefore preferably comprises a generally cylindrical sleeve- or ring-like element having a substantially hollow or open central region which extends between its proximal and distal end regions. In one embodiment, the first input member may have a tapered frusto-conical form, being broadest at its end region proximal the base.

In a preferred form of the invention, the first input member has a generally circular cross-section transverse to its rotational axis, and the outer periphery of the first input member is designed to be gripped and manually rotated by the user. In this regard, the outer periphery of the first input member is preferably profiled or contoured to enhance the ergonomics of the device. For example, the outer periphery may be shaped with a curved concavity and/or provided with ribs to enhance comfort and grip.

In a preferred form of the invention, the diameter of the first input member is less than about 70 mm, preferably less than about 55 mm, and more preferably in the range of about 30 mm to about 40 mm.

The overall height of the device, and particularly the axial extent of the first input member, will typically dictate the orientation or position of the user's hand, especially when the axis of rotation for the first input member is substantially vertical. In a preferred form of the invention, the axial extent of the first input member is less than about 65 mm, and more preferably in the range of about 20 mm to about 50 mm.

In a preferred form of the invention, the movement or actuation of each input member can be performed independently and without affecting the other input member(s).

In a preferred form of the invention, the first input member is mounted for rotary movement about a frame or structure extending upwardly from the base in the central region of the first input member. In such an embodiment, the at least two second input members are preferably provided at an upper end region of the frame. The upper end region of the frame preferably projects beyond the distal end region of the first input member. In this way, the second input members may be provided adjacent the distal end of the first input member. The outer end region of the frame incorporating the at least two second input members may comprise a cap located generally adjacent the distal end region of the first input member.

The user interface device of the invention is typically an accessory device separate from, but connectable for communication with, a computer processor and/or related machinery for manual manipulation and control command input by a user. That connection for communication with the computer processor may be via a cable, or may also be wireless.

In a preferred form of the invention, the base of the user interface device is adapted to support the device on an operating surface, such as a table or desktop, where the device is employed. In one form of the invention, the base has a relatively heavy and robust structure and is designed to remain stationary upon the surface during operation of the device by a user. To this extent, the base may include footings designed to grip the surface. In an alternative form of the invention, however, the base may be designed for translational movement over the supporting surface in such a way that the translational movement also generates a control signal within the computer environment. For example, movement of the base may generate a tracking or pointing signal similar to that created during movement of a conventional mouse device. Furthermore, the base may optionally include a palm rest for the user's hand, although the device is more preferably designed such that no palm rest is required.

In a preferred form of the invention, the axis of rotation of the first input member extends substantially perpendicular to the base or the supporting surface, and is therefore typically a substantially vertical axis. In this regard, it is to be appreciated that terms such as “upwardly” and “upper” used herein with respect to the device of the invention (e.g. with respect to the directional extent of the rotational axis) are to be understood in relation to the ordinary orientation of the device when employed on a table or desktop.

Although the axis of rotation of the first input member is substantially vertical in the preferred embodiments described, it should be understood that the user interface device of the invention also contemplates embodiments in which the rotational axis of the first input member is arranged at angle that is skewed or non-perpendicular to the base or supporting surface. For example, the endeavour to achieve an optimal ergonomic configuration for specific operating conditions may see this axis tilted at an angle in the range of 45° to 90° to the base or supporting surface.

In a preferred form of the invention, the first input member has a home position, and the user interface device is adapted to generate a control signal when the first input member is rotated about its axis away from that home position. The first input member may be rotatable in either or both of the clockwise and counter-clockwise directions about the said axis of rotation. Preferably also, the first input member is resiliently biased, e.g. by one or more spring elements, to return to the home position.

In a preferred form of the invention, the first input member is adapted for“finger-tip control”. That is, the rotary movement of the first input member relative to the base requires a force commensurate with what can be easily applied by an average user's fingers. For example, in the case where the first input member is resiliently biased by one or more spring elements, the spring resistance is typically less than about 15 N/mm, and preferably in the range of about 0.1 to about 10 N/mm, more preferably in the range of about 0.5 to about 5 N/mm, where the displacement (in millimetres) is the rotary displacement at the periphery of the first input member.

In a preferred form of the invention, the rotary movement of the first input member is within a limited angular range, i.e. less than 360°. The range of rotary movement of the first input member may, for example, be less than about 120°, possibly less than about 60°, and possibly even less than about 30°. In one particular example, the rotary movement of the first input member is limited to an angular range of about 10°. The range of rotary movement is preferably evenly distributed in the clockwise and counter-clockwise directions to either side of the home position.

In a preferred from of the invention, each second input member is configured as a switch or a relay, and the user interface device is adapted to generate a corresponding control signal when each said second input member is manually activated. Each said second input member is most preferably in the form of a push-button switch or relay such that activation of each said second input member is via the application of downward finger pressure.

In a preferred form of the invention, the control signal generated upon actuation of at least one of said first or second input members is programmable. In other words, the device is preferably able to be programmed to determine or set the particular control signal generated upon actuation of the first input member and/or each of the second input members—that is, to set the particular function of the input member. In this respect, the user interface device of the invention preferably includes operating software designed to enable the control signal associated with actuation of a particular input member to be altered or set to one of a number of possible alternatives. The operating software is preferably also designed to enable parameters of the device such as the response speed and/or the sensitivity of the input members to be adjusted.

In a preferred form of the invention, the operating software is adapted to display details of a respective control signal associated with one or more of said input members and/or the possible programmable alternatives on a display monitor associated with the computer processing unit with which the device of the invention is used. The operating software may also be adapted to display the parameters of the device such as response speed and/or sensitivity of the input members. The display may, for example, identify each input member graphically and may use keywords or phrases to identify the corresponding input control signal by its function. Such a display would clearly facilitate use of the device.

In one particularly preferred form of the invention, the device includes two second input members, desirably in the form of push-button switches, which are able to be programmed such that each of those second input member switches performs a function opposite to the other. For example, one of the two second input member switches may be programmed to generate a “Page Up” control signal, while the other generates a “Page Down” control signal. Alternatively, one may be programmed to generate a “Forward” control signal while the other generates a “Back” control signal. Similarly, one switch may be programmed to generate a “Copy” control signal, while the other generates a “Paste” control signal.

In a preferred form of the invention, the user interface device furthermore includes one or more third input members provided on the base adjacent the first input member. Each said third input member is preferably also in the form of a switch or relay adapted to be manually activated in similar fashion to each said second input member. The one or more third input members are preferably not able to be programmed to provide different operational control signals. Rather, each third input member preferably has a pre-set function.

In one form of the invention, in addition to being rotatable, the first input member is also axially displaceable to generate a control signal in the computer-related environment. Accordingly, in at least one embodiment, the first input member is movable in an axial direction upon the frame around which it is mounted. This axial displacement may be in either or both axial directions, and is typically against a resilient bias which acts to return the first input member to an axial home position.

In another form of the invention, at least a portion of the frame around which the first input member is mounted is movable to generate an input control signal. Thus, the movable frame portion may itself constitute an input member of the user interface device. For example, the frame portion may be pivotable or translatable relative to the base of the device to generate a control signal. The pivotable or translational movement of the frame portion is preferably against a resilient bias, e.g. from spring elements, which acts to return the frame portion to a neutral position.

As before with the rotary movement, the pivotal and/or translational movement of the first input member is preferably designed for “finger-tip control” and simply requires a force commensurate with what can be readily applied by an average user's fingers. In this regard, the resilient bias of spring elements for pivotal and/or translational movement of the first input member is typically less than about 15 N/mm, and preferably in the range of about 0.1 to about 10 N/mm, more preferably in the range of about 0.5 to about 5 N/mm.

The user interface device of the invention incorporates a sensor arrangement which, among other things, is designed to detect and interpret rotary movement of the first input member relative to the base. In a preferred form of the invention, the user interface device incorporates a sensor arrangement for the detection of relative movements or the relative position of two objects as described in US patent publication No. 2003/0103217, the entire contents of which are incorporated herein by reference. Accordingly, the sensor arrangement is preferably designed to detect and interpret rotary movement of the first input member and/or axial displacement of the first input member and/or pivoting or translational movement of the frame portion upon which the first input member is mounted. The sensor arrangement is typically housed within the central space encompassed by the first input member, e.g. within the hollow central region of a sleeve- or ring-like element, but may also be partially housed within the base. The sensor arrangement may therefore be firmly mounted upon the base, e.g. on or within the frame around which the first input member is preferably mounted.

The user interface device of the invention is preferably designed for one-handed operation by a user, although two-handed operation is also contemplated. Thus, the overall volume of the device should be able to be substantially enclosed within one of the user's hands, as is typically the case with a conventional mouse.

The user interface device of the invention is most particularly envisaged for applications in image or model manipulation with CAD/CAM software and image processing software. In particular, the control signals generated upon movement or actuation of the input members of the device are preferably related to free navigation of the point of view of a digital image or model, enabling both zoom and pan operations to be performed simultaneously. The configuration of the inventive device has the advantage of providing the user with a very natural and intuitive way to explore and manipulate images and designs in the computer environment.

The present invention also provides a system for image generation and/or manipulation in a computer environment, wherein the system includes a user interface device according to the invention as described above. For example, the system may be a CAD/CAM software system.

### BRIEF DESCRIPTION OF THE DRAWINGS

Particular embodiments of the user interface device according to the present invention are hereafter described by way of example with reference to the accompanying drawings, in which like reference characters designate like parts throughout the several views, and in which:

FIGS. 1A to 1C are schematic perspective views of three different sized user interface devices according to particular embodiments of the invention;

FIG. 2A is a more detailed schematic perspective (partially sectioned) of the preferred embodiment of the invention shown in FIG. 1C;

FIG. 2B is a schematic top view of the preferred embodiment shown in FIG. 2A;

FIG. 3A is detailed schematic perspective (partially sectioned) of another preferred embodiment of the invention similar to that shown in FIG. 2A;

FIG. 3B is a schematic top view of the preferred embodiment shown in FIG. 3A; and

FIGS. 4A to 4D are schematic front, top, side and perspective views of a user interface device according to a preferred embodiment of the invention.

### DETAILED DESCRIPTION OF THE PREFERRED EMBODIMENTS

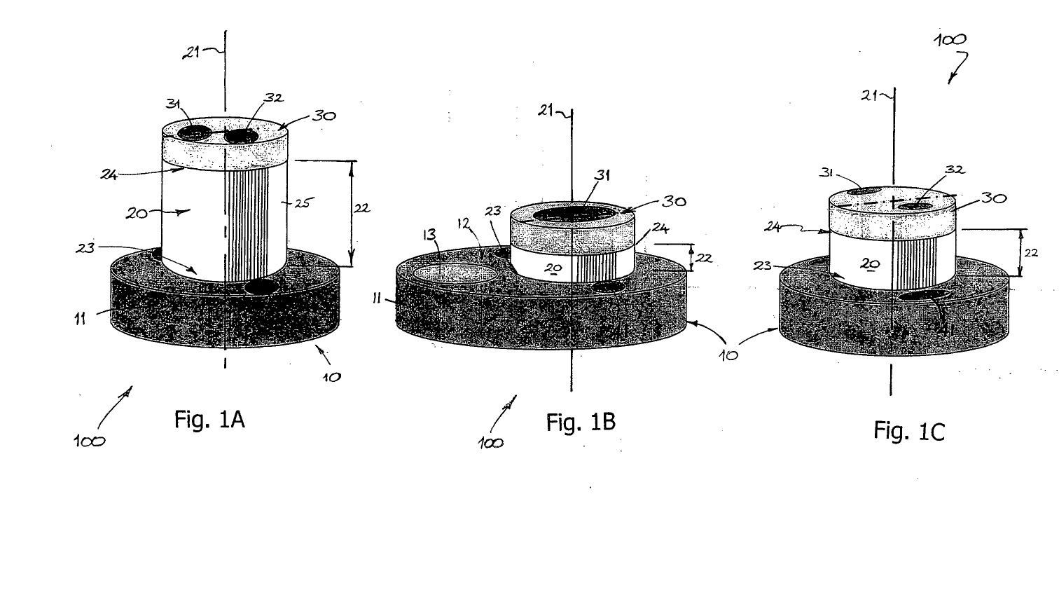

Referring firstly to FIGS. 1A to 1C, perspective views of three different examples of a user interface device (100) according to the invention are schematically illustrated. In each case, the device includes a base (10) comprising a substantially circular or oval-shaped support structure (11). The base (10) is typically robust and is designed to rest in a substantially fixed position on an operating surface, such as on a table or desktop. To this end, an underside of the base (10) may include rubber footings (not shown) for gripping the upper surface of the table or desktop. The base support structure (11) is itself also designed to at least partially house the operating electronics for the device, as will be more fully described below.

A first user input member (20) in the form of a substantially cylindrical sleeve- or ring-like element extends upwardly from and an upper side (12) of the base structure (11). This sleeve- or ring-like first input member (20) is mounted on the base (10) for rotary movement about an axis (21) that extends upwardly substantially perpendicular to the base, i.e. substantially vertically relative to the horizontal desktop. Thus, the cylindrical or ring-like first input member (20) is in the form of a rotary knob and has an axial extent or height (22) from an end region (23) proximal the base (10) to an opposite end region (24) distal from the base. The side walls (25) of the first input member (20) have a generally circular cross-section transverse to the rotational axis (21) and enclose a space within which a sensor arrangement is mounted for detecting and interpreting rotary movement of the first input member (20) relative to the base (10). Thus, the side walls (25) of the cylindrical sleeve or ring-like element enclose a hollow or open region (not shown) which extends between the proximal and distal end regions (22, 23).

The range of rotary movement of the first input member (20) in this example is less than about 30°, and may be only an angular range of about 10° to either side of a rotational home position. The ring-like first input member (20) is preferably resiliently biased by spring elements (not shown) to return to the rotational home position. Importantly, the first input member (20) is adapted for “fingertip control”, such that its rotary movement relative to the base can be easily achieved with average finger strength. In particular, where the ring-like first input member (20) is resiliently biased by spring elements, the spring resistance is typically in the range of about 0.5 to about 5 N/mm.

Adjacent the distal end region (24) of the first input member (20) is a cap component (30) which is not adapted for rotary movement relative to the base. Incorporated at an upper surface of the cap component (30) is at least one push-button switch or relay (31, 32), which forms a second input member. As is clearly visible in the schematic drawings, the embodiments shown in FIG. 1A and FIG. 1C incorporate two second input members (31, 32), while the embodiment shown in FIG. 1B illustrates just a single larger second input member button (31).

Furthermore, FIGS. 1A to 1C show that each of the example embodiments includes two push-button type third input members (41) provided at the upper surface (12) of the base (10) adjacent the proximal end (23) of the first input member knob (20).

In the case of each of these embodiments, rotation of the first input member knob (20), and/or actuation of one of the push-button switches (31, 32) in the cap component (30), and/or actuation of the push-button switches (41) by a user generates a corresponding control signal in the image processing computer environment for which the input devices are designed. The primary difference between the three examples shown in FIGS. 1A to 1C is the axial extent or height (22) of the sleeve- or ring-like first input members (20). These three different heights (22) essentially define three different hand positions for the user. The embodiment shown in FIG. 1A has a relatively tall cylindrical sleeve element (20) up to about 70 mm, and requires a substantially “vertical” hand orientation for proper use. Accordingly, the sleeve element (20) is grasped between the thumb and at least index finder and middle finger, with the palm of the hand in a generally vertical orientation.

The embodiment shown in FIG. 1B, by the contrast, has a first input member with a short axial extent (22) of only about 20 mm. For proper operation of this particular user interface device (100), the hand is preferably in a substantially “horizontal” orientation, with the index finger resting on top of the cap component (30), while the thumb and middle finger grasp the ring-like element of the first input member (20). Due to the orientation of the user's hand in this embodiment, the base (10) is designed to incorporate a palm rest (13) and is therefore somewhat larger than the base in the embodiment shown in FIG. 1A.

FIG. 1C shows an embodiment in which the height (22) of the cylindrical sleeve or ring-like element of the first input member (20) is between the two embodiments shown in FIGS. 1A and 1B, typically in the range of 20 to 50 mm. This configuration provides for a generally “diagonal” or angled hand orientation in which the first input member (20) is grasped between the thumb and index finder of the user. Of the three embodiments illustrated in FIGS. 1A to 1C, this third embodiment having the “diagonal” hand orientation has been found to provide the best performance and ergonomics.

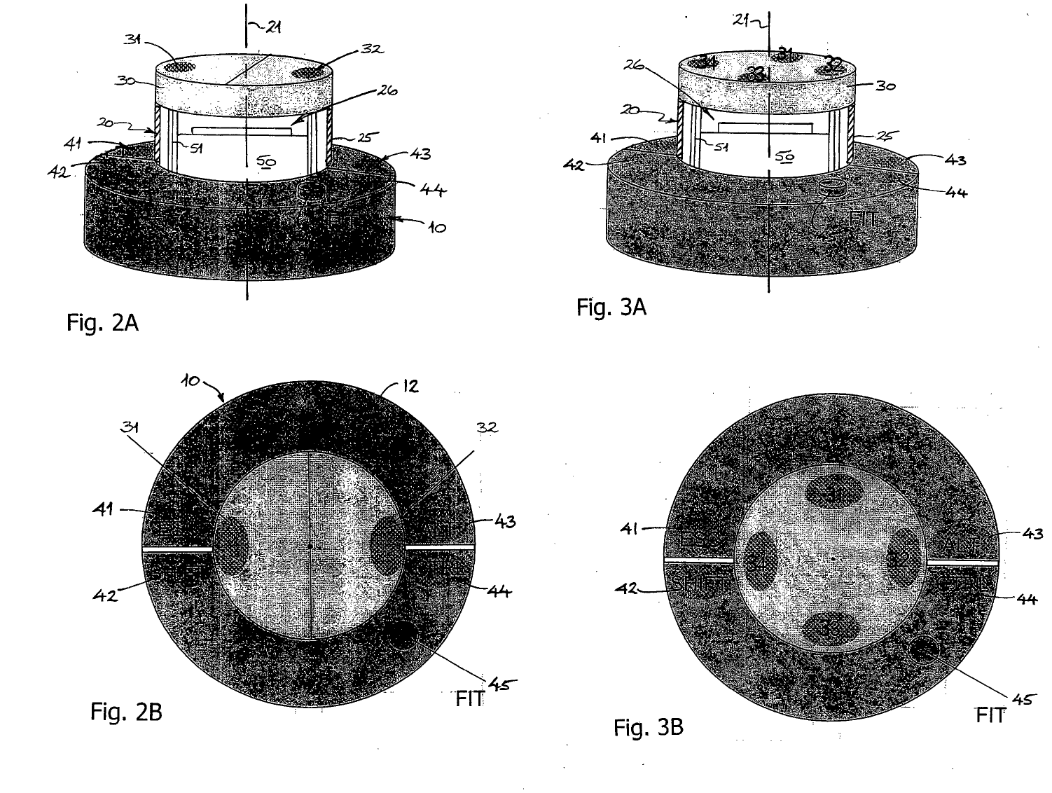

The details of the user interface device (100) of the invention shown in FIG. 1C are further described with reference to FIGS. 2A and 2B. FIG. 2A shows the cylindrical sleeve or ring-like element of the first input member (20) ‘cut away’ to reveal the central space (26) it encloses for at least partially housing the sensor arrangement (50) which detects and interprets the rotary movement of the first input member (20) relative to the base (10). The cylindrical side wall (25) of the first input member (20) is shown sectioned. It will be appreciated that the representation of the first input member (20) as a plain cylindrical element in these drawings is merely a simplified schematic representation. In reality, the outer side surfaces of the first input member (20) are preferably shaped or profiled for comfortable and ergonomic operation by a user. In this regard, the outer surface may have a curved concave profile and may optionally include ribs or texturing to enhance grip. For the purposes of illustrating the basic construction of the device, however, the plain cylindrical form of the first input member (20) generally suffices.

As can be seen in FIG. 2A, the first input member (20) is mounted for rotation about a frame (51) which extends upwardly from the base (10) through the hollow central region (26) of the first input member (20) and culminates in the cap component (30). This frame (51) provides a structure for supporting the cap component (30) and the pair of second input member switches (31, 32) provided thereon, not to mention a supporting structure for the sensor arrangement (50) and for the rotary knob member (20). The sensor arrangement (50) may, for example, be based on the arrangement described in US patent publication no. 2003/0103217 and is adapted to detect and interpret at least the rotary movement of the knob (20) relative to the base (10). That sensor arrangement (50) is at least partially housed within the sleeve or ring-like knob (20), although it is typically also partially housed within the supporting structure (11) of the base (10). The rotary movement of the knob or ring-like first input member (20) about the rotational axis (21) is independent of the two second input member switches (31, 32). Similarly, the actuation of any one of the second input member switches (31, 32) does not in any way affect the first input member (20).

FIG. 2B shows a top or plan view of the user interface device. In this view it can clearly be seen that the circular cap component (30) is divided into left and right halves, each of which forms one of the second input switches (31, 32). The user interface device furthermore includes operating software designed to enable the control signal generated by each of these switches to be programmed. Accordingly, the operating software enables the control signal for each of the second input member switches (31, 32) to be selected and set from a group of alternatives. Each of these two second input member switches (31, 32) is typically programmed to perform a function or to generate an operating control signal the opposite of the other. For example, the pair of second input member buttons may be programmed to: “Undo-Redo”, “Page Up-Page Down,” Home-End”, “Back-Forward”, or “Copy-Paste”.

As can also be clearly in FIG. 2B of the drawings, the base structure (11) incorporates five button-type switches or relays (41, 42, 43, 44, 45) constituting a group of third input members for the user interface device (100). Four of these third input switches (41, 42, 43, 44) are labelled with specific operating control functions. Accordingly, these four of the third input member switches (41, 42, 43, 44) are not programmable, but rather are adapted to always generate the same control signal corresponding to the particular label. In this regard, the labels ESC, ALT, SHIFT and CTRL have the usual meanings and operations as are known in the art. The fifth of the third input member switches (45) is identified as a FIT switch, which is an operation specific to the image processing application for which the device (100) of the invention is adapted. In particular, this switch is designed to “fit” a particular selected portion of an image to the image display screen.

FIGS. 3A and 3B of the drawings illustrate another embodiment of the invention. This embodiment is very similar to the embodiment shown in FIGS. 2A and 2B, with the main difference being the fact that in this case there are four programmable second input members (31, 32, 33, 34) provided evenly distributed around the cap component (30). In all other respects, the device (100) is essentially the same.

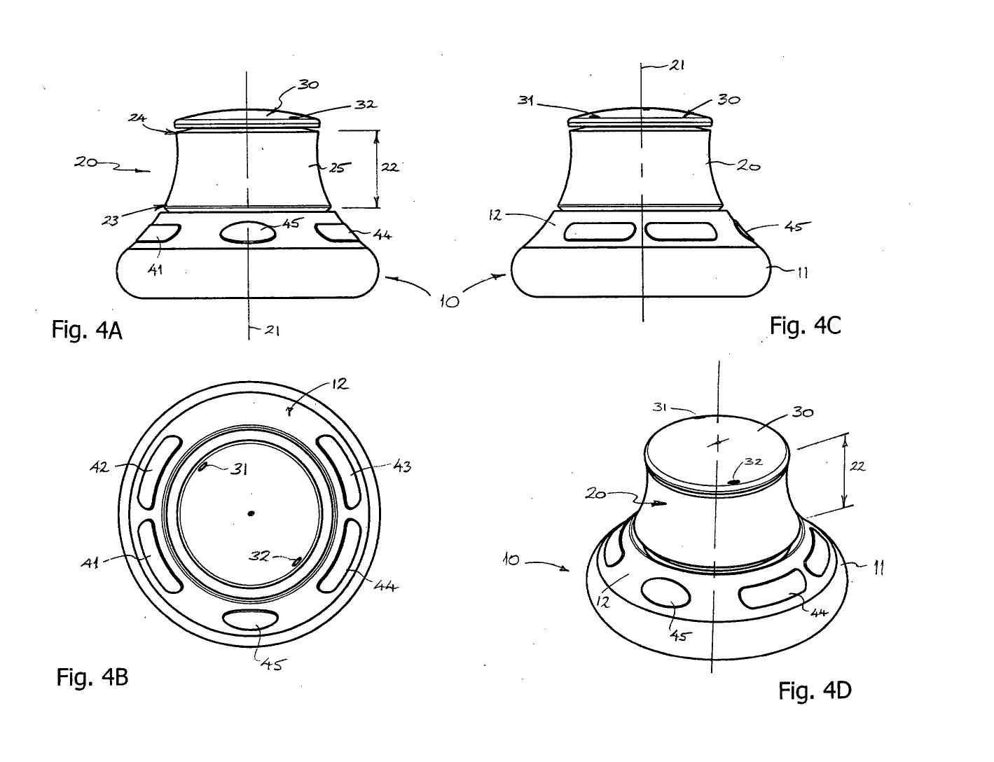

FIGS. 4A to 4D of the drawings illustrate a more realistically rendered embodiment of the invention. In this case, the user interface device (100) has a more curved, more rounded and generally more ergonomic configuration, although its basic structure remains the same as that described above. In this embodiment, the rotary knob of the first input member (20) has a slightly conical configuration, with concave side walls (25) preferably covered with a soft rubber-based compound providing good grip properties for a user. The cap component (30) is an integral element adjacent the distal end region (24) of the rotary knob of the first input member (20) and is adapted to pivot or rock to either side under finger pressure from a user to actuate the two diametrically opposite second input member switches (31, 32). The third input member switches (41, 42, 43, 44, 45) are in the form of elongate buttons distributed around the upper surface (12) of the circular base structure (11).

A possible variation of the device (100) concerns the number of individual second and third input member switches. It will be understood that the number of individual second input member switches (31, 32) and third input members (41-45) in the examples given may vary without departing from the scope of this invention.

Another possible variation of the device (100) described above with reference to the drawings envisages that the sleeve or ring-like element of the first input member (20) may also the displaceable in an axial direction to generate a further control signal. Furthermore, the first input member (20), and/or at least a portion of the frame (51) around which the first input member (20) is mounted for rotation, may be pivotable relative to the base (10) to also generate a further input control signal. Accordingly, in one embodiment, lateral pressure applied to the side of the knob (20) and cap component (30) (i.e. in the forward, rearward or sideways directions) is designed to pivot the movable portion of the frame (51)—and the knob (20) and cap component (30) with it—relative to the base (10) to thereby generate a further input control signal. Again, the pivotal or translational movement of the first input member (20) is typically adapted for finger-tip control, against a spring bias in the range of about 0.5 to about 5 N/mm.

The user interface device (100) of the present invention, particularly in the preferred configuration illustrated in FIGS. 4A to 4D, provides a compact and very user-friendly device for freely navigating the point of view of a digital image or model, and enabling both zoom and pan operations to be performed simultaneously. The rotation of the knob (20) may, for example, generate a “pan” control signal, while axial displacement of the knob (20) and/or actuation of one of the second input member switches (31-34) may effect a zoom operation. Thus, the device (100) of the invention can provide the user with a very natural and intuitive way to explore and manipulate images and designs in the computer environment, particularly within a CAD/CAM or image processing software application. Another advantage of the invention is that it reduces the necessity for the user to make frequent hand motions to and from and operating keyboard—especially when pre-set keyboard functions are pre-programmed in the third input member switches (41-45).

The user interface device (100) of the invention is typically envisaged for operation in conjunction with a regular computer monitor and keyboard and a conventional computer mouse. The user interface device (100) of the invention may, for example, be operated in the user's left hand, in which case the user will typically operate the conventional mouse with his/her right hand. The conventional mouse and keyboard remain integral elements of the overall computer design process, with the mouse typically being used in 2D drafting mode, e.g. in a “sketching phase” for sketching geometries, and for selecting and confirming commands. The keyboard meanwhile is typically used to input numbers (such as dimensions) and text (such as file names).

The user interface device (100) of the invention is especially suited to motion control input with 3D models, objects and designs; for example, in a design “finishing phase” during which design details are added, as well as in “editing, assembling and understanding phases” during which the dimensions of the components may be controlled and modified, and the completed components assembled together. Nonetheless, the device (100) may also be adapted for operation in the 2D mode, thereby reducing the user's reliance on the conventional mouse.

It will be understood that alterations and/or additions may be made to the various parts of the device (100) described with reference to the accompanying drawings without departing from the scope of the present invention.

1. A device (100) for manual input of control signals in a computer-related environment, the device comprising:
a base (10) for supporting the device on a surface;
a first input member (20) mounted on the base (10) for rotary movement about an axis (21) extending generally upwardly from the base (10), the first input member (20) having an axial extent (22) from an end region (23) proximal the base (10) to an end region (23) distal from the base and enclosing a central space (26) within which a sensor arrangement (50) is housed for detecting and interpreting rotary movement of the first input member (20) relative to the base, the first input member (20) having an opening at each of its proximal and distal end regions (23, 24); and
at least two second input members (31, 32) provided at or adjacent said distal end region (24) of the first input member, each of said second input members (31, 32) comprising a switch or relay adapted to be actuated by application of finger pressure;
wherein rotary movement of the first input member (20) and/or actuation of the second input members (31, 32) is adapted to generate a corresponding control signal within the computer environment and wherein the at least two second input members (31, 32) are mounted such that rotary movement of the first input member (20) relative to the base does not influence or alter a position of the two second input members (31, 32).

2. A device according to claim 1, wherein the first input member (20) comprises a generally cylindrical sleeve- or ring-like element having a substantially hollow or open central region (26) which extends between the said proximal and distal end regions (23, 24).

3. A device according to claim 1, wherein the first input member (20) has a generally circular cross-section transverse to its rotational axis (21).

4. A device according to claim 1, wherein the movement or actuation of each input member (20, 31, 32) can be performed independently without affecting the other input member(s).

5. A device according to claim 1, wherein the diameter of the first input member (20) is less than about 70 mm, and preferably less than about 55 mm.

6. A device according to claim 1, wherein the axial extent (22) of the first input member (20) is less than about 65 mm, and more preferably in the range of about 20 mm to 50 mm.

7. A device according to claim 1, wherein the first input member (20) is mounted for rotation about a frame (51) which extends from the base generally centrally of the first input member (20), and wherein the second input members (31, 32) are provided at an upper end region (30) of the frame (51).

8. A device according to claim 7, wherein the upper end region (30) of the frame (51) projects beyond the distal end region (24) of the first input member (20).

9. A device according to claim 1, wherein the axis of rotation (21) of the first input member (20) extends substantially perpendicular to the base (10).

10. A device according to claim 1, wherein the rotary movement of the first input member is within a limited angular range, said angular range being preferably less than about 120°, more preferably less than about 60°, and even more preferably less than about 30°.

11. A device according to claim 1, wherein the first input member (20) has a rotational home position, and the user interface device is adapted to generate a control signal when the first input member (20) is rotated about its axis away from said home position.

12. A device according to claim 11, wherein the first input member (20) is resiliently biased to return to said home position.

13. A device according to claim 1, wherein the first input member (20) is adapted for rotary movement in either or both of the clockwise and counter-clockwise directions about the rotational axis (21).

14. A device according to claim 1, wherein the first input member (20) is adapted for “finger-tip control”, such that the rotary movement of the first input member relative to the base requires a force commensurate with what can be easily applied by an average user's fingers.

15. A device according to claim 13, wherein the resilient bias of the first input member (20) is less than about 15 N/mm, preferably in the range of about 0.1 to about 10 N/mm, and more preferably in the range of about 0.5 to about 5 N/mm.

16. A device according to claim 1, wherein the second input members (31, 32) are configured as push-button switches or relays, and the user interface device is adapted to generate a control signal when each said second input member is manually activated via the application of finger pressure.

17. A device according to claim 1, wherein the control signal generated upon movement or actuation of at least one of said first or second input members (20, 31, 32, 33, 34) is programmable.

18. A device according to claim 17, including operating software designed to enable the respective control signal associated with actuation of a particular input member (20, 31, 32, 33, 34) to be altered or set to one of a number of possible alternatives.

19. A device according to according to claim 1, including operating software designed to enable parameters of the device such as response speed and/or sensitivity of the input members to be adjusted.

20. A device according to claim 18, wherein the operating software is adapted to display details of a respective control signal associated with one or more of said input members (20, 31, 32, 33, 34), and/or said possible alternatives, on a display monitor associated with the computer processing unit with which the device (100) is used.

21. A device according to claim 1, wherein the two second input members (31, 32) are programmed such that each of said second input members performs an opposite function to the other.

22. A device according to claim 1, wherein the device (100) includes four second input members (31, 32, 33, 34), preferably able to be programmed.

23. A device according to claim 1, further including one or more third input members (41, 42, 43, 44, 45) provided on the base adjacent the first input member.

24. A device according to claim 23, wherein each said third input member (41, 42, 43, 44, 45) is in the form of a switch or relay adapted to be manually activated in similar fashion to each said second input member.

25. A device according to claim 23, wherein the one or more third input members (41, 42, 43, 44, 45) are not programmable to provide different operational control signals, but rather have pre-set functions.

26. A device according to claim 1, wherein the base (10) is designed for translational movement over a supporting service in such a way that the translational movement generates a control signal within the computer environment.

27. A device according to claim 1, wherein, in addition to being rotatable, the first input member (20) is displaceable in an axial direction relative to the base to also generate a control signal in the computer-related environment.

28. A device according to claim 27, wherein the first input member (20) is displaceable in either or both axial directions, preferably against a resilient bias which acts to return the first input member to an axial home position.

29. A device according to claim 1, wherein at least a portion of the frame (51) around which the first input member is mounted is movable to generate an input control signal.

30. A device according to claim 29, wherein the frame portion (51) is pivotable, translatable, or both pivotable and translatable relative to the base (10) of the device to generate a control signal.

31. A device according to claim 30, wherein the frame portion (51) has a resilient bias against said pivotable and/or translational movement, which bias acts to return the frame portion to a neutral position.

32. A device according to claim 29, wherein application of lateral pressure to the first input member (20) is adapted to pivot or translate said frame portion relative to the base (10).

33. A device according to claim 1, wherein the sensor arrangement (50) is designed to detect and interpret rotary movement of the first input member and/or axial displacement of the first input member and/or pivoting or translational movement of the frame portion.

34. A device according to claim 1, wherein the sensor arrangement (50) is mounted on or within the frame (51).

35. A device according to claim 1, wherein the base (10) is adapted to support the device on an operating surface, such as a table or desktop.

36. A device according to claim 1, wherein the device (100) is designed for one-handed operation by a user.

37. A system for image generation and/or manipulation in a computer environment, wherein the system includes a user interface device (100) according to claim 1.
